(19) United States
(12) Patent Application Publication
(10) Pub. No.: US 2010/0247960 A1
(43) Pub. Date: Sep. 30, 2010

(54) PATTERNED ECC AND GRADIENT ANISOTROPY MEDIA THROUGH ELECTRODEPOSITION

(75) Inventors: Jiaoming Qiu, Saint Paul, MN (US); Ibro Tabakovic, Edina, MN (US); Mark T. Kief, Lakeville, MN (US); Hieu T. Lam, Milipitas, CA (US); David S. Kuo, Palo Alto, CA (US); Jie Gong, Eden Prairie, MN (US)

Correspondence Address: SEAGATE TECHNOLOGY Outside Counsel Dergosits;& Noah LLP, Three Embarcadero Center, Suite 410, San Francisco, CA, 94111, US

(73) Assignee: Seagate Technology LLC, Scotts Valley, CA (US)

(21) Appl. No.: 12/415,654

(22) Filed: Mar. 31, 2009

(51) Int. Cl. G11B 5/62; G11B 5/84

(52) U.S. Cl. 428/800; 205/112

(57) ABSTRACT

An electrodeposited magnetic recording medium having multiple coercivity values is disclosed. In some embodiments, layers having different coercivity levels may be separated by exchange coupled composites and in other embodiments a range of coercivity levels are deposited in a gradient fashion. In some embodiments, the layers with multiple coercivity values comprise bit patterned media islands formed from a photoresist.

### BACKGROUND

In magnetic disk drive storage technology, the fluctuation of magnetization due to thermal agitation is called the superparamagnetic effect. The superparamagnetic effect posses a serious challenge for continuing to increase the areal density and storage capacity of disc drives and other magnetic recording media.

Current magnetic recording media adopt a perpendicular magnetic recording method in which recording is performed so that a magnetic material is magnetized in a direction perpendicular to the surface of a disk. Perpendicular recording has helped push out the superparamagnetic limit to achieve higher recording densities and has become the state-of-art technology for the magnetic recording industry. However, continued increases in recording density will still need to face the superparamagnetic limit and new approaches need to be introduced. This is because bit density is increased by reducing the size of the recorded bits on the media. Thus, as each bit consists of a certain number of grains, the volume of the magnetic fine grain is significantly reduced; thereby a superparamagnetic effect becomes remarkable again. That is, energy stabilizing the direction of magnetization is reduced by thermal energy, and recorded magnetization changes with the progress of time, thereby sometimes causing erasure of recording.

### SUMMARY

In one embodiment in accordance with the invention, a magnetic recording medium includes a substrate with a plurality of dots deposited on the substrate. The dots have a first electroplated ferromagnetic composition having a first coercivity and a second electroplated ferromagnetic composition having a second coercivity.

In another embodiment in accordance with the invention, a magnetic recording medium with a substrate has a ferromagnetic composition electrodeposited thereon. The ferromagnetic composition has a variable coercivity that generally changes relative to the distance from the substrate. The coercivity should increase or decrease as the distance from the substrate increases.

In another embodiment in accordance with the invention, a method for depositing a magnetic recording medium on a substrate includes placing the substrate in an electrolytic solution. A first ferromagnetic material is electrolytically deposited on the substrate. The electroplating potential or current density of the electrodeposition process is then changed, and a second ferromagnetic material is electrolitically deposited on the first ferromagnetic material.

These and various other features and advantages will be apparent from a reading of the following detailed description.

### BRIEF DESCRIPTION OF THE DRAWINGS

The following drawings are illustrative of particular embodiments of the invention and therefore do not limit the scope of the invention. The drawings are not to scale (unless so stated) and are intended for use in conjunction with the explanations in the following detailed description. Embodiments of the invention will hereinafter be described in conjunction with the appended drawings, wherein like numerals denote like elements.

FIG. 1 is a schematic process flow diagram of a resist patterning process in accordance with embodiments of the invention.

FIG. 2 is a graph of X-Ray diffraction patterns of cobalt platinum films obtained with and without organic additive.

FIG. 3 is a Hysteresis loop of a cobalt platinum film in accordance with embodiments of the invention.

FIG. 4 is a schematic representation of an exchange coupled composite (ECC) recording medium in accordance with embodiments of the invention.

FIG. 4A is a schematic representation of a recording medium in accordance with embodiments of the invention.

FIG. 5 is a graph showing alloy composition as a function of relative applied voltage during electrodeposition in accordance with embodiments of the invention.

FIG. 6 is a schematic representation of a gradient anisotropy recording medium in accordance with embodiments of the invention.

### DETAILED DESCRIPTION

One of the most promising methods to circumvent the density limitation imposed by the superparamagnetic effect is the use of bit-patterned media (BPM). The concept is that each bit is stored in a single lithographically defined magnetic switching volume, i.e. dot. The formation of sub-25 nm dots represents a great challenge in terms of fabrication and large volume manufacturing. Different methods for fabricating nano-holes with diameter of sub-25 nm with adequate spacing corresponding to the areal density of 1 Tbit/in² have been demonstrated. The formation of nano-dots by electrodeposition of hard magnetic material with perpendicular anisotropy through lithographically obtained nano-holes is one embodiment of the present invention.

An exemplary perpendicular media comprises a multilayer structure including a substrate covered by a soft magnetic under layer (SUL), an interlayer and hard bit-patterned magnetic layer. The hard magnetic layer can be cobalt platinum alloy material of hexagonal close-packed crystal structure (“hcp-crystal structure”) with crystalline grains oriented along the c-axis (a vertically oriented crystal axis, usually the principal axis) in the direction normal to the film planes and with a well-defined orientation. An important magnetic property is high out-of-plane coercivity (Hc), which is largely determined by magnetocrystalline anisotropy and to lesser extent by shape anisotropy of magnetic grains. Additional benefits include magnetic properties such as, remanent magnetization (Mr), remanence squareness of the hysteresis loop (Mr/Ms), sufficient magnetic anisotropy (Ku), negative nucleation field (Hn) and small grain size but within the thermal stability limit. Moreover, the grain boundaries should be able to magnetically isolate the neighboring grains from each other to a large extent.

The electrodeposition of cobalt platinum and cobalt platinum phosphorous alloys according to certain embodiments of the present invention is one possible method for fabrication of bit patterned media and MEMS devices.

Generally, cobalt platinum alloys showed a low perpendicular coercivity (Hc=200-1000 Oe) in as-deposited state at room temperature. Annealing of cobalt platinum nano-wires deposited into Al₂O₃ templates at 700° C. gave high perpendicular coercivity (Hc=8000-10000 Oe). Electrodeposition of cobalt platinum alloy in external magnetic field of 1 Tesla applied in the plane normal direction gave Hc (perp.)=6100 Oe. However electrodeposition without applied magnetic field produced Cobalt platinum films with low perpendicular coercivity (Hc=600 Oe).

Cobalt platinum phosphorous electrodeposited thin films with coercivities as high as 4500-7000 Oe occur at the thickness of Cobalt platinum phosphorous film from 100 to 600 nm. However, at the thickness of interest in bit-patterned media (10-15 nm), the perpendicular coercivities were rather low, i.e. 600-800 Oe, which makes cobalt platinum phosphorous electrodeposited alloys less optimal for BPM.

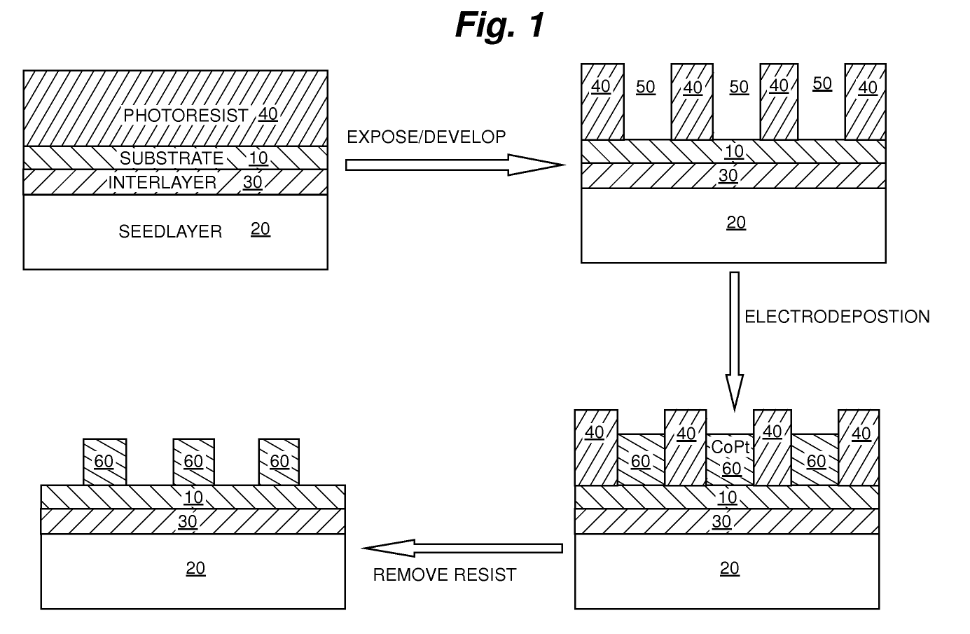

FIG. 1 is a schematic process flow diagram of a resist patterning process in accordance with embodiments of the invention. A process for electrodeposition of cobalt platinum alloys capable of possessing high perpendicular coercivity of 6700 Oe measured as deposited film or 8500 Oe coercivity when cobalt platinum was deposited into nanoholes of 30 nm diameter may generally follow this process flow.

In another embodiment in accordance with the invention, a bit-patterned media comprising electrodeposited cobalt platinum dots, a seed layer, an inter layer, and a substrate can be produced. The structurally oriented seed layer 10, which can be Cu, Cr, Ag, NiCu, Ru or other appropriate material, may be deposited on a substrate 20 or on an interlayer 30 that was previously deposited on the substrate 20 prior to resist patterning. A photoresist 40 is patterned into an array of nanoholes 50 by, for example, photolithography or other acceptable methods. The formation of nano-dots (islands) 60 is carried out by electrodeposition of cobalt platinum 60 and subsequent removal of the photoresist 40.

The process of electrodeposition is analogous to a galvanic cell acting in reverse. The seed layer 10 may be the cathode of the circuit. In one technique, an anode or anodes are made of the metal to be plated on the part. Both components are immersed in an electrolyte that may contain one or more dissolved metal salts as well as other ions that permit the flow of electricity. Direct current may be supplied to the cathode causing the metal ions in the electrolyte solution to lose their charge and plate out on the cathode. As the electrical current flows through the circuit, the anode slowly dissolves and replenishes the ions in the bath.

In one exemplary embodiment, the cobalt platinum dots 60 may be produced from a solution containing 0.5M NH₄Cl₂, 0.4M H₃BO₃, 0.1M CoSO₄, 3 mM PtCl₂ or H₂PtCl₆, 0.01 mM NaLS and 3 mM of an organic additive at constant current density (0.7-1.2 mA/cm²) without agitation of plating solution.

Organic additives found to be effective in producing such dots or films include the following:

(1) Heterocyclic compounds:

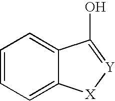

### Where X may be O, S, NH, CO, CH₂, SO, or SO₂ and Y may be N, CH, C—CH₃, or C—Ph.

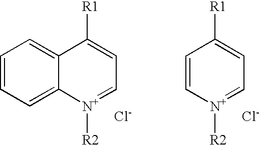

Where R1 may be CH₃, CH₃CH₂ or CH₃CH₂CH₂CH₂ and R2 may be CH₃ or CH₃CH₂, CH₃CH₂CH₂CH₂.

(2) C₆H₃— compounds:

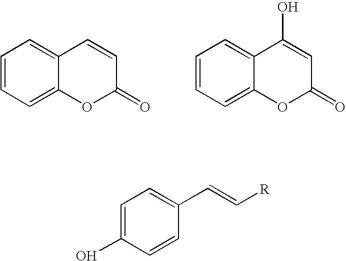

### Where R may be CH₂OH, CH₃, C₆H₅.

(3) Semicarbazide compounds:

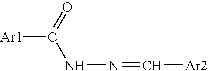

Where Ar1 may be C₆H₅, p-OH—C₆H₅, 2-Furyl, 2-Thienyl, or NH₂ and Ar2 may be C₆H₅, p-OH—C₆H₅, 2-Furyl, 2-Thienyl, or NH₂.

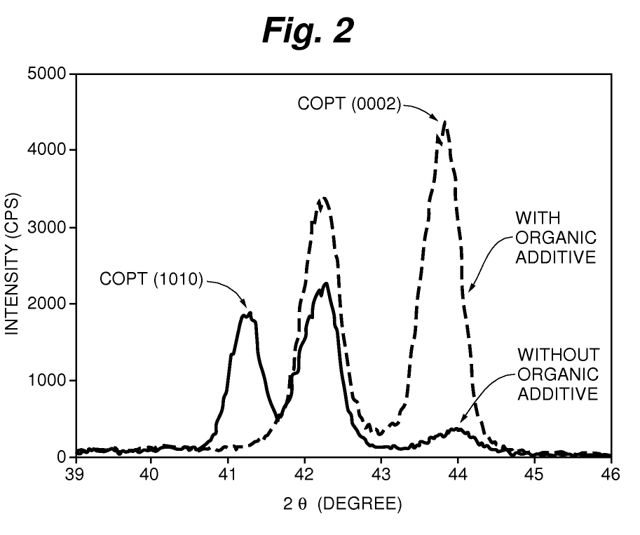

FIG. 2 is a graph of X-Ray diffraction patterns of cobalt platinum films obtained with and without organic additive. The x-axis represents the X-ray incidence angle (theta) times two and the y-axis represents the intensity of diffracted X-ray beam in counts per second (cps). The peaks in the graph correspond to the different crystallographic planes that constructively interfere with the X-ray beam. As a result, information about the peak intensity and its position on the x-axis provides the texture, crystallinity, and crystallite thickness of the film. High intensity and narrow peak width indicate better texture control and high quality crystal growth. As can be seen, the organic additive for electrodeposition of hcp-structured cobalt platinum films affects the crystal growth favorably. X-Ray diffraction images of cobalt platinum films electrodeposited on an ruthenium-seed layer with and without the presence of organic additive show that the presence of this additive favors the growth of hcp cobalt platinum grains with their hexagonal c-axis perpendicular to the film. At the same time the organic additive adsorbs selectively at the point where the suboptimal hexagonal grains with the coplanar c-axis (indicated at 1010 on FIG. 2) preventing growth of cobalt platinum at that plane and promoting the growth of cobalt platinum with superior grain structure (indicated at 0002 on FIG. 2).

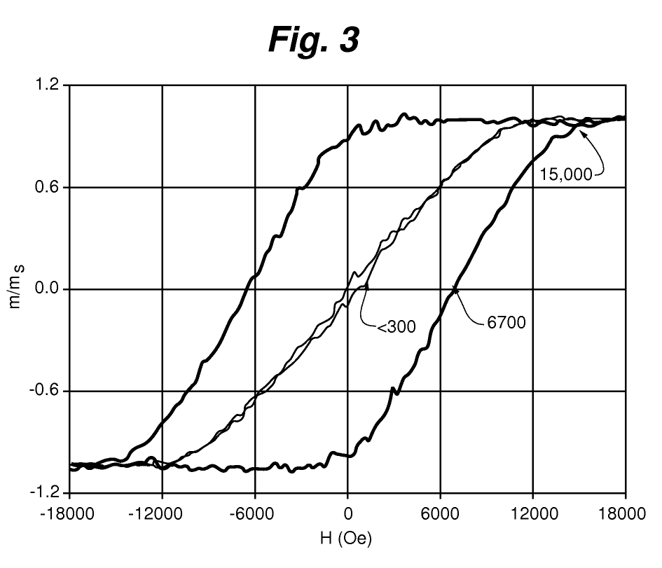

FIG. 3 is a hysteresis loop of a cobalt platinum film in accordance with embodiments of the invention. In one example in accordance with embodiments of the invention, a superior cobalt platinum film was achieved by electrodeposition on a ruthenium seed layer in a plating solution containing 0.5M NH₄Cl, 0.4M H₃BO₃, 0.1M CoSO₄, 3 mM H₂PtCl₆ and 3 mM organic additive. Vibrating Sample Magnetrometer (VSM) measurement of cobalt platinum film (˜15 nm) showed Hc (out-of-plane)=6700 Oe and Hc (in-plane)<300 Oe and saturation field of 15000 Oe.

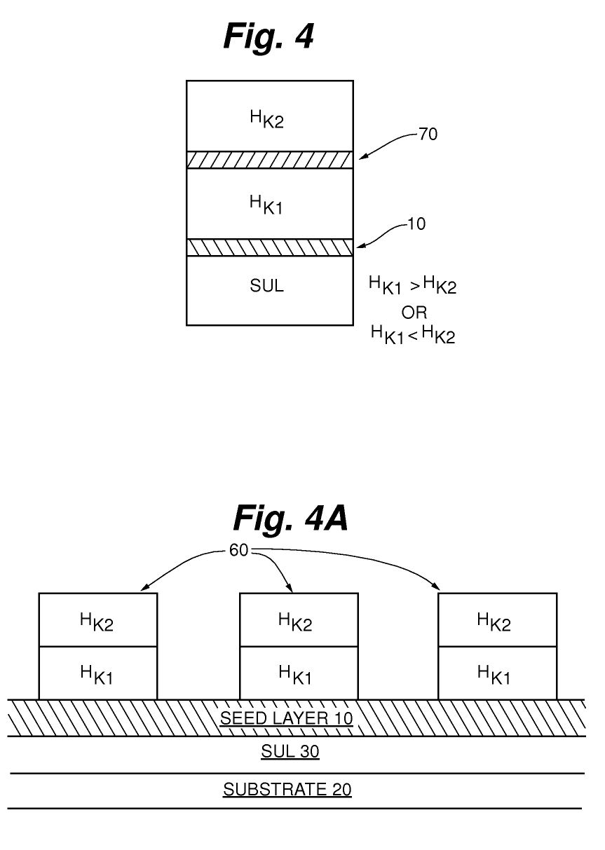

Products produced in accordance with embodiments of the invention may be even more valuable if layers of material having different anisotropy, and thus coercivity levels, can be produced within one deposited ferromagnetic deposit. FIG. 4 is a schematic representation of an exchange coupled composite (ECC) recording medium in accordance with embodiments of the invention. In the embodiment in FIG. 4, there is a soft underlayer SUL that is not used to record data. A non-magnetic seed layer 10 is disposed upon the soft underlayer SUL.

A first ferromagnetic layer H_{K1} is disposed on top of the seed layer 10. A non-magnetic exchange coupling layer 70 is disposed on top of the first magnetic layer H_{K1}, and a second magnetic layer H_{K2} is disposed on top of the exchange coupling layer 70. The exchange coupling layer 70 will be non-magnetic and could be formed of, for example, platinum. These layers can all be formed in a single bath electrodeposition process with the compositions of the various layers effected by changing the electrodeposition cathodic electrode plating potential or current density as described below.

The layers H_{K1} and H_{K2} will have different anisotropy levels and coercivity levels, with one having a relatively high coercivity or resistance to magnetic fields (referred to as “hard”) and the other having relatively low coercivity (referred to as “soft”). Either H_{K1} or H_{K2} could be the soft layer, and the other would be the hard layer.

ECC BPMs in accordance with embodiments of the invention can be formed by electrodeposition of cobalt and platinum to form alloys of various concentrations of each metal. In embodiments where these metals are used, cobalt-rich compositions are relatively soft with lower coercivity and compositions with less cobalt (e.g. the compositions close to Co₃Pt) are relatively hard with higher coercivity.

In cases where this recording medium is deposited in a bit-patterned fashion, an individual dot or deposit (60 of FIG. 1) may have a layered structure. For example, with reference to the embodiments of FIG. 4A, each island 60 can comprise H_{K1} and H_{K2} layers. A plurality of such islands 60 can be formed on seed layer 10, which resides on a substrate 20 or a soft under layer 30 which has been previously deposited on the substrate 20. The seed layer 10 can act as the cathode in an electrodeposition process. Optionally, each island 60 can also include EC Layer 70 between H_{K1} and H_{K2}, as in the embodiment of FIG. 4.

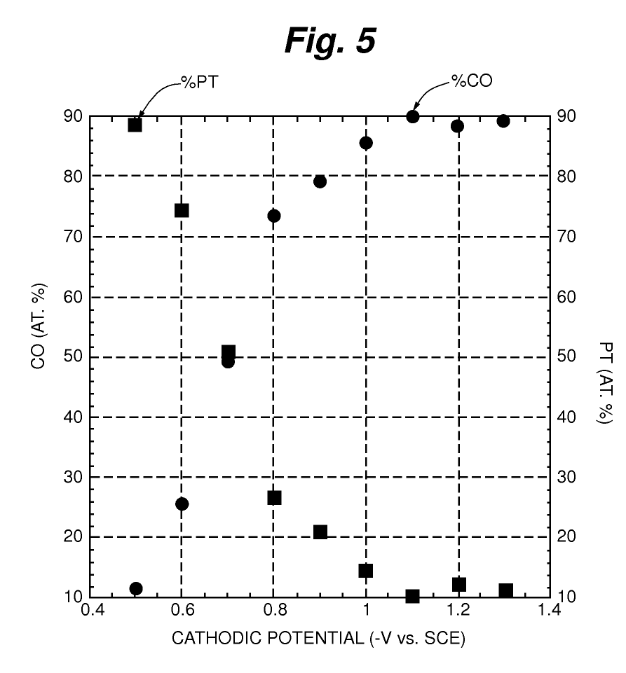

FIG. 5 is a graph showing alloy composition as a function of relative applied voltage during electrodeposition in accordance with embodiments of the invention. The graph show relative cobalt and platinum compositions versus the relative electrolytic potential measured against a standard carbon electrode. The data points indicated by circles on the graph indicate atomic percent cobalt in the composition and the data points indicated by squares indicate atomic percent platinum.

In this example, the soft magnetic layer, which, in some embodiments, is pure cobalt or cobalt rich alloys, can be plated by using potentials at the high end (−1.0V to −1.5 V depending on the bath composition). The exchange coupling layer, which is typically platinum or platinum rich alloys, can be plated by using potentials at the low end (−0.3V to −0.5 V). The hard magnetic layer, which is cobalt platinum alloy with composition around 75 at % Co, can be plated by using potentials in between −0.8 V to −0.9V.

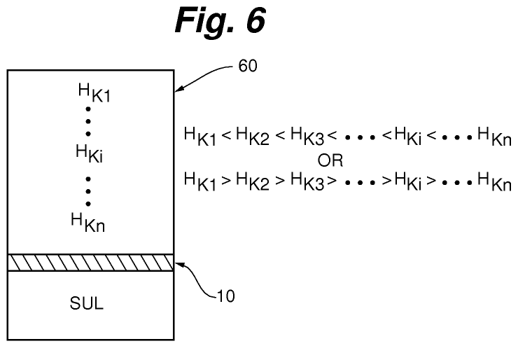

FIG. 6 is a schematic representation of a gradient coercivity recording medium in accordance with embodiments of the invention. A magnetic recording media having coercivity levels that regularly ascend or descend through the thickness of the deposition can be created by continuously adjust the plating potential or current density. No exchange coupling layer is necessary, although one or more ECC layers could be deposited if desired.

The embodiment shown in FIG. 6 can be deposited, for example, by using the electrolytic solution described above and operating the bath with a cathodic potential within the range associated with the graph shown in FIG. 5. The deposition could begin with a cathodic potential of −1.0 to 1.5V and through the deposition the potential could be regularly adjusted until it reaches −0.8V or lower. In this embodiment the recording medium would be relatively soft nearest the seed layer 10 and increasingly hard further from the seed layer 10. Of course, the process could be reversed to get a hard medium near the feed layer that softens as additional layers are added.

Gradient coercivity recording media or ECC recording media can be produced electrolytically from a single bath electrodeposition by varying the electroplating potential or current density as described herein. Variations will occur to those of skill in the art upon reading this disclosure and the implementations described above and others are within the scope of the following claims. The embodiment in FIG. 6 can also be applied to a bit patterned media application similar to FIG. 4A.

The implementations described above and other implementations are within the scope of the following claims.

What is claimed is:

1. A magnetic recording medium comprising:
a. a substrate comprising a plurality of dots deposited on the substrate, the dots comprising;
i. a first electroplated ferromagnetic composition having a first coercivity; and
ii. a second electroplated ferromagnetic composition having a second coercivity.

2. The magnetic recording medium of claim 1, wherein the ferromagnetic compositions comprise platinum and cobalt alloys.

3. The magnetic recording medium of claim 1, further comprising an exchange coupled composite layer between the first ferromagnetic composition and the second ferromagnetic composition.

4. The magnetic recording medium of claim 1, wherein the dots are formed by electrodeposition into a pattern of cavities previously formed in a photoresist.

5. The magnetic recording medium of claim 1, wherein the first ferromagnetic composition is deposited at a first controlled potential or current density and the second ferromagnetic composition is deposited at a second controlled potential or current density.

6. The magnetic recording medium of claim 1, wherein the first ferromagnetic composition is deposited from a solution containing ammonium chloride, boric acid, cobalt sulfate, hexachloroplatinic acid and an organic additive.

7. The magnetic recording medium of claim 6, wherein the organic additive is selected from the group consisting of:
(1) Heterocyclic compounds; 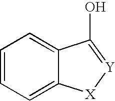
Where X may be O, S, NH, CO, CH₂, SO, or SO₂ and Y may be N, CH, C—CH₃, or C—Ph; or 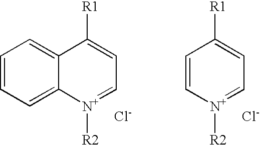
Where R1 may be CH₃, CH₃CH₂ or CH₃CH₂CH₂CH₂ and R2 may be CH₃ or CH₃CH₂, CH₃CH₂CH₂CH₂;
(2) C₆H₃— compounds; 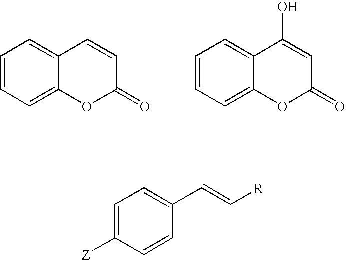
Where Z may be OH and R may be CH₂OH, CH₃, C₆H₅; and
(3) Semicarbazide compounds: 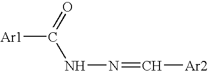
Where Ar1 may be C₆H₅, p-OH—C₆H₅, 2-Furyl, 2-Thienyl, or NH₂ and Ar2 may be C₆H₅, p-OH—C₆H₅, 2-Furyl, 2-Thienyl, or NH₂.

8. The magnetic recording medium of claim 2, wherein the first ferromagnetic composition comprises at least 85 atomic percent cobalt and the second ferromagnetic composition comprises at least 70 atomic percent cobalt.

9. A magnetic recording medium comprising a substrate with a ferromagnetic composition having a variable coercivity electrodeposited thereon, the coercivity of the ferromagnetic composition generally changing relative to the distance from the substrate.

10. The magnetic recording medium of claim 9, wherein the coercivity of the composition increases in the direction away from the substrate.

11. The magnetic recording medium of claim 9, wherein the coercivity of the composition decreases in the direction away from the substrate.

12. The magnetic recording medium of claim 9, wherein the ferromagnetic composition is deposited as a plurality of dots.

13. The magnetic recording medium of claim 9, wherein the ferromagnetic composition is electrodeposited and the controlled potential or current density is gradually changed throughout the deposition to form the ferromagnetic composition of variable coercivity.

14. The magnetic recording medium of claim 9, wherein the ferromagnetic composition comprises a cobalt and platinum alloy and the ratio of platinum to cobalt changes relative to the distance from the substrate.

15. The magnetic recording medium of claim 9, wherein the ferromagnetic composition is deposited from a solution containing ammonium chloride, boric acid, cobalt sulfate, hexachloroplatinic acid and an organic additive.

16. The magnetic recording medium of claim 15, wherein the organic additive is selected from the group consisting of:
(1) Heterocyclic compounds; 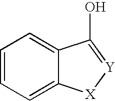
Where X may be O, S, NH, CO, CH₂, SO, or SO₂ and Y may be N, CH, C—CH₃, or C—Ph; or 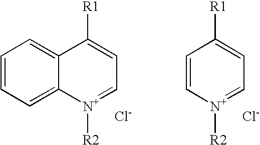
Where R1 may be CH₃, CH₃CH₂ or CH₃CH₂CH₂CH₂ and R2 may be CH₃ or CH₃CH₂, CH₃CH₂CH₂CH₂;
(2) C₆H₃— compounds; 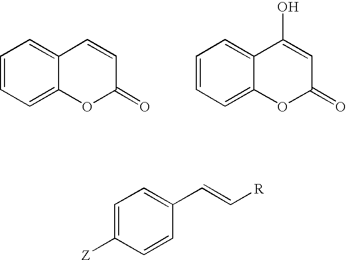
Where Z may be OH and R may be CH₂OH, CH₃, C₆H₅; and
(3) Semicarbazide compounds: 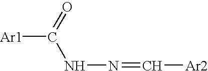
Where Ar1 may be C₆H₅, p-OH—C₆H₅, 2-Furyl, 2-Thienyl, or NH₂ and Ar2 may be C₆H₅, p-OH—C₆H₅, 2-Furyl, 2-Thienyl, or NH₂.

17. A method of depositing a magnetic recording medium on a substrate comprising:
placing a substrate in an electrolytic solution;
electrolytically depositing a first ferromagnetic material on the substrate;
changing a controlled potential or current density of the electrodeposition process; and
electrolytically depositing a second ferromagnetic material on the first ferromagnetic material.

18. The method of claim 17, wherein the first and second ferromagnetic materials comprise platinum and cobalt alloys and wherein the second ferromagnetic material has a higher concentration of cobalt than the first ferromagnetic material.

19. The method of claim 17, further comprising the steps of:
depositing a seed layer on the substrate; and
patterning a photoresist layer on the seed layer into an array of holes to facilitate the creation of a bit patterned media, wherein the seed layer is used as a circuit cathode in the electrolytically depositing steps.

20. The method of claim 17, further comprising the step of gradually changing the controlled potential while continuing to electrolytically deposit ferromagnetic material.
